(19) United States
(12) Patent Application Publication
(10) Pub. No.: US 2012/0090236 A1
(43) Pub. Date: Apr. 19, 2012

(54) Aeroponic Plant Growing System

(76) Inventor: Gregory S. Orr, Golden, CO (US)

(21) Appl. No.: 13/274,816

(22) Filed: Oct. 17, 2011

Related U.S. Application Data
(60) Provisional application No. 61/394,071, filed on Oct. 18, 2010.

(51) Int. Cl. A01G 31/02; A01G 31/00

(52) U.S. Cl. 47/62 A; 47/59 R

(57) ABSTRACT

An aeroponic plant growing system is provided that enhances plant growth by spraying plant roots with a recaptured, ultra-violet purified, and replenishable nutrient solution while simultaneously illuminating plant leaves with power-saving and heat reducing, LED lamps. A rotating platform is also provided that rotates plant holding pods to stimulate the plants and also provide a constant controllable application of water, light, and nutrients.

This application claims the benefit of U.S. provisional patent application Ser. No. 61/394,071, filed Oct. 18, 2010, the entire disclosure of which is incorporated by reference herein.

### FIELD OF THE INVENTION

Embodiments of the present invention generally relate to aeroponic and hydroponic plant growing systems.

### BACKGROUND OF THE INVENTION

Hydroponics is a method of growing plants using nutrient solutions in water and in the absence of soil. Some advantages of using hydroponic growing techniques are that 1) no soil is needed, 2) water and nutrients can be reused, thereby lowering costs, 3) control of nutrient levels is enhanced, 4) little or no pollution is released into the environment, 5) stable and high yields may be achieved, and 5) pests, diseases and soil borne pathogens are easier to address. Some hydroponic systems only use a nutrient solution, while others support plants with inert mediums such as perlite, gravel, mineral wool, coir fiber, or coconut husks.

Aeroponics is a process of growing plants in an aero-mist environment without the use of soil or an aggregate medium. Unlike hydroponics, which uses water as a growing medium, aeroponics is conducted without a growing medium. Hydroponic systems comprise a system where water and nutrients are directly dripped or soaked onto the roots or by way of an associated medium. In many systems, roots are sprayed with nozzles, misted, or fogged. By varying degrees of pressure, atomization, and suspension, some hydroponic processes can generally be categorized as aeroponic. Aeroponic growing systems provide nutrients directly to the roots of suspended plants in a closed or semi-closed environment. Most commonly, the dangling roots and the plant's lower stem are sprayed with an atomized nutrient-rich solution. The roots of the plant are separated from the leaves and crown, which is often called the “canopy,” by a plant supporting structure. Closed cell foam is often compressed around a portion of the plant's lower stem that is inserted into an opening in an aeroponic chamber. For larger plants, trellising is used to suspend the weight of vegetation and fruit.

Aeroponic and hydroponic growing methods avoid the inefficiencies associated with traditional soil growing techniques that limit root expansion which affects leaf and fruit development. Aeroponic and hydroponic plant production is also cleaner and often easier than soil growing techniques. Advances in aeroponic and hydroponic plant growth are associated with enhanced dispersion of root supporting and developing elements, temperature and air control, and growing flexibility. As a result, aeroponics/hydroponic plant growth is not only faster, it is commercially viable and well suited for home growing purposes.

One drawback of prior art aeroponic plant growing systems is related to insufficient root exposure to the nutrient solution. Accordingly, some systems employ a system of angled plant racks that increase root exposure to the nutrient solution spray. To enhance root exposure, it has also been envisioned to angle the spray nozzles, use a slanted plane, use a terraced oxygenator/aspirator and downdrafts, make use of a rotating drum or wheel, or rotate roots through a water container.

To increase production, plants may be moved in relation to a light or water sources or nutrient solution, either by floating rafts or lineal movement of troughs, or various other carriage methods. Plant movement has also been shown to stimulate growth of auxins or other plant growth hormones. Some systems, for example, employ physical plant movement systems or expose plants to shock waves. For example, plants may be moved around a support source that limits the application of only one nutrient substance, and does so in a way that applies the nutrient solution only vertically with respect to the top and bottom surfaces of the exposed plant portion. The same is true for systems that employ moving light sources that vary light exposure only laterally or in a single direction relative to the plants or rotate plants but without simultaneously spraying their roots. Although steps have been taken to use growing space more effectively, especially vertical space, these efforts have fallen short.

To enhance plant growth, applied nutrient solution is collected, regenerated and re-circulated. To avoid infestation by fungi or bacteria, some growing systems pasteurize the collected solution. Other systems apply fungicides or disinfectants, anti-bacterial agents, natural anti-microbials, ultra-violet light, or filters. Present systems also create timed intermittent applications of nutrient solution as well as temperature and nutritional content to promote root growth.

Commonly, as briefly mentioned above, the plant canopies are separated from the roots by walls that create upper and lower growing compartments. In addition, temperature and air regulators are often employed. New methods for providing light to the plants have also been used that involve the application of surrounding lights, diffusing lights, reflection plates, and fiber optics.

Finally, some systems employ a pump/blower to oxygenate the nutrient solution that will enhance the oxygen levels applied to plants. Oxygenator/oxygen emitters, air circulators and oxygen-generating nutrient compositions have also been employed.

Some of the features described above may be found in U.S. Patent Nos. 3,529,379, 3,909,978, 3,973,353, 4,037,360, 4,255,897, 4,332,105, 4,514,930, 4,543,744, 4,583,323, 4,669,217, 4,721,250, 4,780,989, 4,813,176, 4,869,019, 4,965,962, 5,056,260, 5,136,804, 5,168,655, 5,502,923, 5,515,648, 5,584,141, 5,724,768, 5,887,383, 5,918,416, 5,937,575, 5,983,564, 6,000,173, 6,295,759, 6,604,321, 6,615,542, 6,807,770, 6,840,007, 6,957,512, 7,055,282, 7,060,656, 7,143,544, 7,181,886, 7,188,451, 7,401,437, 7,426,802, 7,559,173, 7,600,343, 7,614,132, 7,670,495, and, 4,059,922, the entire disclosures of which are incorporated by reference herein. In addition, some of the features in the following U.S. Published Patent Applications 20050055878, 20050257424, 20070113472, 2004/0062023, 2007/0093387, 2005/0204620, 2005/0198097, 2006/0112630, 2006/0196118, 2006/0156624, 2006/0272205, 2007/0113472, 2008/0110088, 2007/0271841, and PCT/IB2009007727, the entire disclosures of which are incorporated by reference herein.

It is thus a long felt need to provide an aeroponic plant growing system that combines some features of the prior art while addressing the drawbacks of the prior art by adding additional features that enhance plant growth. More specifically, the embodiments of the present invention described herein provide a unified plant production system.

### SUMMARY OF THE INVENTION

It is one aspect of the present invention to provide an aeroponic plant growing system that supplies nutrients, water, light, and air to plants that are situated on a rotating platform. The contemplated system insures thorough penetration of all plant supporting elements and, thus, optimum plant health and growth. The platform supports a plurality of plant growing pods. Further, the platform has apertures that may be adjusted in size to accommodate various plant sizes, spacing, and needs of the cultivator to enhance plant accessibility. The rotation provided by the platform allows for the continuous or near continuous application of light and air from ever-changing angles to the canopy. Plant movement also stimulates the production of growth hormones in the plants. Rotating platforms also ensures the grower has enhanced access to each plant. In one embodiment a plurality of rotating platforms is employed wherein adjacent platforms rotate in opposite directions, i.e, adjacent platforms counter-rotate. Platform counter-rotation avoids canopy entangling and enables the plants to brush against each other, further stimulating plant growth.

The top surface of the grow pod and the supporting media (if any) constitute a barrier between the upper plant environment, which includes the leaves and stems, and lower plant environment, which includes the plant's roots. In one embodiment the application elements that support the upper plant environment and the lower plant environment is separate and computer controlled. Further, separate temperature, humidity, light, and nutrient control of both upper and lower compartment areas is contemplated.

The systems contemplated herein effectively resolve contamination problems by including a fluid recirculation and regeneration pump that destroys microorganisms with each circulation of solution. In one embodiment, the pump employs ultra-violet light and water that has been purified by reverse osmosis. The system also monitors and controls pH and additional oxygen is made available by adding hydrogen peroxide (H₂O₂) to the nutrient solution.

It is another aspect of the present invention to provide a system with an integrated system of air management and an advanced light source. The contemplated light source is, preferably, much cooler and more energy efficient than sodium or metal halide light sources, which results in significantly lower operating costs. In one embodiment, wide-band LED lamp(s) or similar light sources are used to provide a superior growth environment for the upper plant environment. Carbon dioxide or ambient air may also be pumped to the upper plant environments as needed to maintain optimum temperature and air composition around the plants. Finally, a reflective metallic surface on the inside of a tent or other enclosure positioned around the rotating platforms may be used to further direct light onto the plants.

It is yet another aspect of the present invention to provide a smart and comprehensive yet operator-friendly unit that is easy to control and adjust. The contemplated system provides enhanced access to plants, is rugged, is mobile, and is compact. Those of skill in the art will appreciate that the growing systems as described herein are scalable such that any number of plants may be accommodated with their growth controlled in a cost effective manner. For example, one embodiment accommodates twelve medium-sized plants and is approximately four feet wide, eight feet long, and six feet high (not including external controls and support mechanisms).

Thus the system of embodiments of the present invention are well suited to medium to large-sized home and commercial growing operations accommodating medium sized plants.

It is yet another aspect of the present invention to provide a system that facilitates plant growth by utilizing rotating grow pods that simultaneously receive controlled spray directed to their roots by a series of nozzles and controlled light directed to their plant's leaves and stems from an LED lamp(s) or similar light source. In one embodiment of the invention, grow pod rotation is accomplished by securing the pods onto a moveable platform. The grow pods are scalable in size and, thus, spacing of plant-receiving apertures can be optimized as a function of plant type. The grow pods are interconnected to plumbing that feeds nozzles that selectively apply nutrient fluid spray to the roots. The plumbing also retrieves used fluid and redirects it to the nozzles or forwards it to a recycling tank, for example. The spray recirculation, and drain plumbing function while the platform and associated grow pods rotate because, in one embodiment, a revolving fitting is used to connect a lower, vertical portion of the supply plumbing to a horizontal portion of the supply plumbing that is interconnected to the grow pods.

In one embodiment nutrient is delivered, either continuously or intermittently, by a series of computer-controlled systems that control fluid flow to the nozzles. Sensors may be integrated into the grow pod that measure oxygen content, carbon dioxide content, nutrient quality, water quality, etc. of the nutrient solution delivered by the self-enclosed circulation subsystem. Excess fluid is captured in a reservoir to rejuvenate all fluid elements. Nutrient solution contamination is eliminated by utilizing a pump that destroys microorganisms with ultra-violet radiation and by the use of water that is initially purified by the process of reverse osmosis.

Overhead light is also simultaneously applied at selectively adjustable intervals by lights that penetrate the moving plant upper environment. The grow pod top surface and support media, which is supported in grow baskets positioned within the grow pods, provide a functional barrier between the upper plant environment with its controlled air environment associated with the leaves, stems and blossoms or fruit, and the lower plant environment, i.e., the roots. The circular movement of the platform(s) and associated plants allows for 360 degrees of light penetration and exposure of the plant upper environment.

The light source reduces operating costs by replacing traditional metal halide and similar light sources with LED or similar lamps incorporating a wide light band spectrum, which also produces much less heat, enhances growth, and requires as much as 90% less power. Light sources may also be monitored and regulated by a set of sensors and computer controls. The grow pods and rotating platforms of one embodiment is housed in a tent enclosure with a reflective metallic interior surface to further disperse light. The system may also receive carbon dioxide and ambient air and expel oxygen through intake vents and exhaust vents that maintain optimum air quality and temperature. The air quality may be regulated and monitored by sensing and regulating controls with pre-establishable computer controlled settings.

It is another aspect of the present invention to provide a system for aeroponically growing plants, comprising: a stand supported by a plurality of legs; a rotatable platform associated with the stand; a container interconnected to the rotatable platform, the container having a growing basket associated with a top surface of the container and having at least one nozzle for directing fluid at the growing basket; a fluid return pipe interconnected to the container, the fluid return pipe extending through the rotatable platform and through the stand; a fluid supply pipe positioned within the fluid return pipe; and a motor associated with the fluid return pipe by way of a belt wherein the motor selectively rotates the fluid return pipe and the rotatable platform.

It is yet another aspect of the present invention to provide s system for aeroponically growing plants, comprising: a rotatable platform; a container interconnected to the rotatable platform, the container having a growing basket and having at least one nozzle for directing fluid at the growing basket; a fluid return pipe interconnected to the container; and a fluid supply pipe associated with the fluid return pipe.

It is another aspect of the present invention to provide a method for growing plants, comprising: providing a container that is positioned on a selectively rotatable platform, the container having a growing basket that is adapted to receive at least one plant wherein the roots of the plant are positioned within the growing basket and the leaves of the plant extend from the container; rotating the platform; directing fluid to the container; directing the fluid via at least one nozzle to the growing basket; collecting the fluid; directing the fluid into a catch basin; purifying the fluid; and selectively exposing the plants to light.

It is another aspect of embodiments of the present invention to provide a system for aeroponically propagating plants comprising a chamber to house plants and supporting apparatus which separates the plant root environmental area from the upper plant environment through the use of one or more grow pods with apertures into which plant baskets are placed, effectively separating the two environmental areas from each other.

The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

To assist in the understanding of one embodiment of the present invention the following list of components and associated numbering found in the drawings is provided herein:

| # | Component |
|---|---|
| 2 | Grow pod |
| 6 | Rotating platform |
| 10 | Plant basket |
| 14 | Drain fitting |
| 18 | Support media |
| 22 | Plant upper portion |
| 26 | Plant lower portion |
| 30 | Spray nozzles |
| 34 | Nutrient solution supply piping |
| 38 | Nutrient solution return piping |
| 42 | Drive motor |
| 46 | Drive mechanism |
| 50 | Reversing drive mechanism |
| 54 | Main stand |
| 58 | Nutrient solution catch vessel |
| 62 | Nutrient solution |
| 66 | Nutrient solution return pump |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

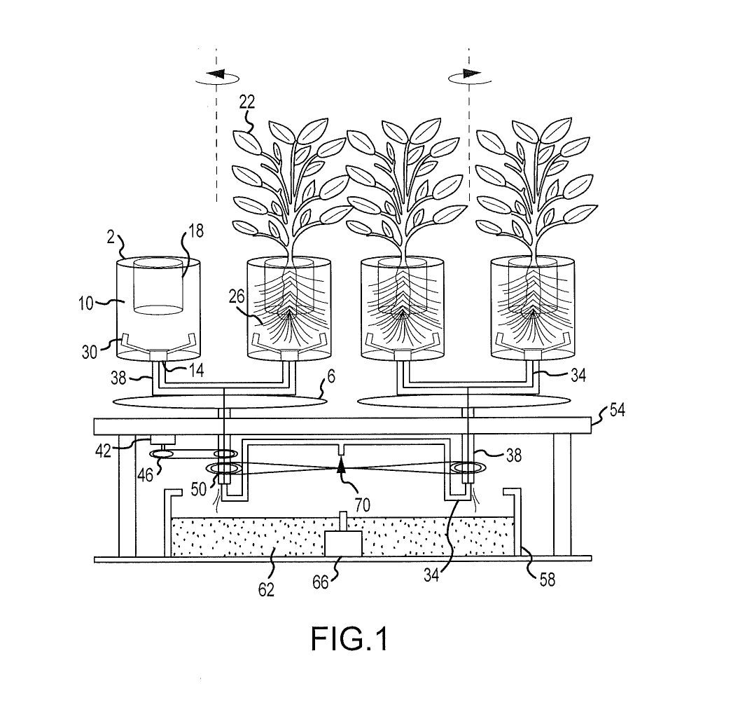

FIG. 1 shows one embodiment of the present invention that employs a plurality of grow pods 2 interconnected to rotating platforms 6. Grow pods 2 consist of a cylindrical receptacle that is fitted with a lid having a hole to accommodate and support a mesh plant basket 10. The mesh plant basket 10 of one embodiment is a five-inch plastic basket with multiple openings through which the roots 26 protrude. Further, the plant basket of one embodiment includes a lip around its top edge that allows it to hang in a grow pod aperture. Nutrient solution is delivered to the grow pod 2 by piping via fitting 14 that is integrated into a bottom surface of the grow pod. Support media 18 is found within the plant basket 10 and may be comprised of clay pellets or other support media commonly used in aeroponic growing applications.

In operation, the upper portion of the plant 22 will be positioned above the support media 18 while the lower portion 26, i.e., roots, will be held in place by the support media 18. The support media 18 and roots will be exposed to growing solution applied by a plurality of spray nozzles 30. The spray nozzles 30 are mounted on opposite sides of the bottom of the grow pod 2 and are supplied by a nutrient solution supply piping 34 that is coaxial with the nutrient solution return piping 38, which is interconnected to the drain fitting 14. The nutrient solution return piping 38 of one embodiment of the present invention is constructed of 1.25-inch schedule 40 PVC.

In order to facilitate growing, it is advantageous to rotate the plants to provide even exposure to light and nutrients. Accordingly, in one embodiment of the present invention the grow pods 2 are associated with a rotating platform 6. Here, two grow pods 2 are shown interconnected to the rotating platform. One of skill in the art will appreciate that depending on the size of the grow pods and platform, any number of grow pods 2 may be accommodated without departing from the scope of the invention. The rotating platform 6 is driven by a drive motor 42 and drive mechanism 46 that is interconnected to a vertical portion of the nutrient return drain pipe 38 via a belt or gears, for example. When actuated, the drive motor 42 drives the drive mechanism 46, which may be a series of pulleys or gears, to rotate the vertical portion of the return piping 38, the rotating platform 6 and thus the individual grow pods 2. A reverse drive mechanism 50 is associated with vertical sections of return piping of an adjacent grow pod such that when one platform rotates 6, the adjacent platform 6 will rotate in an opposite direction. One of skill in the art will appreciate that the drive motor associated with the rotating platforms may be a computer controlled servo motor. Further, each platform may have its own motor and be independently controlled, if desired. Reversing the direction of the adjacent platform greatly reduces the chance that plants associated with adjacent platforms will become entangled. The drive mechanisms 50, drive motor 42, and rotating platforms 6 are supported by a stand 5 that in one embodiment is about 2 feet by 4 feet with 12 inch legs.

In one embodiment of the present invention, the rotating platform 6 is a 15 inch diameter plastic or equivalent disc with the nutrient solution return piping 38 attached to its top and mounted to the main stand 54 with a lazy susan type ball bearing transfer unit. In one embodiment, the drive motor 42 is 110 volt AC gear motor and the rotating platform drive mechanism 46 is a gear belt that transfers rotation generated by the drive motor 42 to the first rotating platform nutrient solution drain pipe.

In operation, nutrients and water are received from a nutrient solution supply tank 70 via nutrient solution supply tubing. The grow pod supply tubing 34 runs through the center of each drain pipe 38 into the grow pod 2 and uses bearings or fittings that allow the drain piping 38 to rotate while the lower portion of the supply tubing 34 is stationary. The nutrient solution is delivered to the plant through a plurality of nozzles 30 and drains from the grow pod 2 though the return piping 38 and eventually into a catch vessel 58. The catch vessel 58 maintains the level of nutrient solution 62 until a pump 66 is activated, either manually or automatically to transfer the fluid back to the nutrient solution supply tank 70. One of skill in the art will appreciate that the nutrient solution may be treated before transferring to the supply tank to remove bacteria, microbes and other impurities, add hydrogen peroxide, balance pH, add nutrients, etc.

While various embodiment of the present invention have been described in detail, it is apparent that modifications and alterations of those embodiments will occur to those skilled in the art. Moreover, references made herein to “the present invention” or aspects thereof should be understood to mean certain embodiments of the present invention and should not necessarily be construed as limiting all embodiments to a particular description. However, it is to be expressly understood that such modifications and alterations are within the scope and spirit of the present invention, as set forth in the following claims.

What is claimed is:

1. A system for aeroponically growing plants, comprising:
a stand supported by a plurality of legs;
a rotatable platform associated with said stand;
a container interconnected to said rotatable platform, said container having a growing basket associated with a top surface of said container and having at least one nozzle for directing fluid at said growing basket;
a fluid return pipe interconnected to said container, said fluid return pipe extending through said rotatable platform and through said stand;
a fluid supply pipe positioned within said fluid return pipe; and
a motor associated with said fluid return pipe by way of a belt wherein said motor selectively rotates said fluid return pipe and said rotatable platform.

2. The system of claim 1, further comprising:
a second rotatable platform associated with said stand;
a second container interconnected to said rotatable platform, said second container having a growing basket associated with a top surface of said second container and having at least one nozzle for directing fluid at said growing basket;
a second fluid return pipe interconnected to said second container, said second fluid return pipe extending through said second rotatable platform and through said stand;
a second fluid supply pipe positioned within said second fluid return pipe; and
a belt that interconnects said first fluid return pipe to said second fluid return pipe, wherein rotation of said fluid return pipe in one direction imparts rotation in an opposite direction in the second rotatable platform.

3. The system of claim 1, wherein said rotatable platform accommodates more than one container.

4. The system of claim 1, wherein said at least one nozzle comprises two selectively positionable nozzles.

5. The system of claim 1, wherein the fluid that is expelled from said at least one nozzle is directed via said fluid return line to a storage tank.

6. The system of claim 5, wherein said fluid is treated and pumped to said fluid delivery pipe.

7. The system of claim 6, wherein said nutrient solution is treated with ultraviolet lights.

8. A system for aeroponically growing plants, comprising:
a rotatable platform;
a container interconnected to said rotatable platform, said container having a growing basket and having at least one nozzle for directing fluid at said growing basket;
a fluid return pipe interconnected to said container; and
a fluid supply pipe associated with said fluid return pipe.

9. The system of claim 8, further comprising:
a second rotatable platform positioned adjacent to said first rotatable platform;
a second container interconnected to said rotatable platform, said second container having a growing basket and having at least one nozzle for directing fluid at said growing basket;
a second fluid return pipe interconnected to said second container; and
a second fluid supply pipe associated with said second fluid return pipe.

10. The system of claim 9, wherein said rotatable platform and said second rotatable platform are mechanically associated such that rotation of one rotatable platform will impart opposite rotation in the adjacent rotatable platform.

11. The system of claim 8, wherein rotation of said rotatable platform is imparted by a motor that is mechanically associated with at least one of said rotatable platform or said fluid return pipe.

12. The system of claim 8, wherein said rotatable platform and said second rotatable platform are rotated by computer controlled servo motors.

13. The system of claim 8, wherein said rotatable platform accommodates more than one container.

14. The system of claim 8, wherein said container employs a supporting apparatus that engages a portion of the plant and separates the upper portion of the plant from the roots of the plant.

15. The system of claim 8, wherein further comprising at least one lamp that selectively directs light onto said container.

16. The system of claim 15, wherein a timer is used to control the duration and intervals of light exposure.

17. The system of claim 8, further comprising an enclosure positioned around said rotating platform

18. The system of claim 17, wherein both ambient exterior air and carbon dioxide are provided to said enclosure and exhausted air is removed from said enclosure.

19. The system of claim 17, further comprising atmospheric sensors and control mechanisms located exterior and interior to said enclosure that monitor and control the content and temperature of the air in said enclosure.

20. The system of claim 17, wherein said interior surface of said enclosure is at least partially reflective and by virtue of platform rotation, the plants are exposed to light directed from an ever-changing variety of angles from 360 degrees.

21. The system of claim 8, wherein said rotatable platform is rotated at controlled intervals and speeds.

22. The system of claim 8 further comprising a nutrient solution transport system associated with said fluid supply pipe and said fluid return pipe that provides continuous or intermittent, ultra-violet light-purified nutrient solution to said at least one nozzle.

23. The system of claim 22 wherein said nutrient solution is routed from said container to a holding tank where it is tested, replenished with nutrients as needed, enriched with hydrogen peroxide as needed, pH controlled, and pumped back to said at least one nozzle.

24. A method for growing plants, comprising:
providing a container that is positioned on a selectively rotatable platform, said container having a growing basket that is adapted to receive at least one plant wherein the roots of the plant are positioned within said growing basket and said leaves of said plant extend from said container;
rotating said platform;
directing fluid to said container;
directing said fluid via at least one nozzle to said growing basket;
collecting said fluid;
directing said fluid into a catch basin;
purifying said fluid; and
selectively exposing said plants to light.
